(19) United States
(12) Patent Application Publication
(10) Pub. No.: US 2009/0283649 A1
(43) Pub. Date: Nov. 19, 2009

(54) Utility Brackets for Securing Components to Structures

(76) Inventors: Jeffrey H. Wood, Eureka, MO (US); Elizabeth Y. Lenger, Kirkwood, MO (US); Gary D. Renieri, Chesterfield, MO (US); David P. Heck, St. Peters, MO (US); Randy A. Southmayd, Florissant, MO (US)

Correspondence Address: HUGH P. GORTLER, 23 Arrivo Drive, Mission Viejo, CA, 92692, US

(21) Appl. No.: 12/510,257

(22) Filed: Jul. 27, 2009

Related U.S. Application Data
(62) Division of application No. 11/861,031, filed on Sep. 25, 2007.
Application No. 11/861,031 is a division of application No. 10/633,295, filed on Jul. 31, 2003, now abandoned.

(51) Int. Cl. F16B 47/00; A47B 96/06

(52) U.S. Cl. 248/205.3

(57) ABSTRACT

Utility brackets for attaching system components (e.g. wires or wire bundles) to structures are provided. The utility bracket includes a first portion that supports a product and a second portion for adhering to a support structure. The second portion includes a separation component that separates the second portion from the support structure by a predefined amount. The separation component includes a plurality of ridges or dimples for allowing even application of an adhesive. A nut plate or wire ties secure the product to the first portion. The second portion can include a base plate that is rotatably coupled to the first portion. The bracket can be formed by a molding or extruding process.

### CROSS REFERENCE TO RELATED APPLICATIONS

This patent application is a divisional application of co-pending, commonly-owned U.S. patent application Ser. No. 10/633,295 entitled “Utility Bracket” filed on Jul. 31, 2003, which application is incorporated herein by reference.

### FIELD OF THE DISCLOSURE

This disclosure relates generally to support systems and, more specifically, to utility brackets for securing system components to a structure.

### BACKGROUND OF THE DISCLOSURE

Complex systems, such as electrical systems in aircraft, utilize numerous utility brackets for securing many parts, such as electrical wire bundles (FIG. 1). Brackets are currently drilled and riveted to the aircraft structure (FIG. 2). This process requires locating, clamping, drilling the bracket in place, and installing multiple rivets to attach the bracket. There currently exists an unmet need to reduce part count and installation labor costs.

FIG. 3 illustrates an alternative apparatus to the bolted or riveted utility bracket. A utility bracket 30 is adhesively bonded to a structure 32. The bracket 30 is an improvement over the drilled and riveted bracket system shown in FIG. 2, because the steps required to drill and rivet the bracket are not needed. A person mounting the bracket 30 to the structure 32 simply applies adhesive to the structure 32 or the surface of the bracket 30 that is to be mounted on the structure 32, and then mates the utility bracket 30 with the structure 32. However, if too much or not enough pressure is applied when mating the utility bracket 30 to the structure 32, the amount of adhesive applied may end up being too thin or too thick between the utility bracket 30 and the structure 32, thereby producing a less than adequate bond.

The utility bracket 30 utilizes a frame device (not shown) to alleviate this problem by supporting the utility bracket 30 after it is adhesively bonded with the structure 32. The frame device controls the adhesive bondline thickness between the utility bracket 30 and the structure 32, but adds an additional expense and requires the extra steps of installation prior to adhesive bonding, and then removing the frame device after the adhesive is cured. Also, the size of the frame device may limit the location freedom of the utility bracket 30 due to interference with nearby structure.

Therefore, there also currently exists an unmet need to quickly and effectively bond utility brackets to structures by controlling the adhesive bondline thickness, while closely replicating the size and function of the current mechanically attached bracket.

In addition, the current utility bracket is located in a fixed orientation that dictates the path of all connected components. If wire bundles are attached to the bracket, the wire bundles have a natural tendency to follow a specific path that could cause straining or over-bending of the wire bundles, which could occur because the utility bracket only allows a single axis of rotation. Thus, there currently remains an unmet need to design and manufacture a utility bracket that will swivel to provide multiple rotational axes, whereby components such as wire bundles can follow a general path without undue straining or over-bending.

### SUMMARY

The present disclosure provides utility brackets for attaching system components (e.g. wires or wire bundles) to a structure, such as an aircraft. The present disclosure provides an easy to install bracket with known adhesive capabilities.

The utility bracket includes a first portion that supports a product and a second portion that adheres to a support structure. The second portion includes a separation component (geometric feature) that separates the second portion from the support structure by a predefined distance. The predefined distance is based on properties of an adhesive that is applied between the second portion and the support structure.

In one aspect of the disclosure, the separation component includes a plurality of ridges or dimples.

In another aspect of the disclosure, the second portion is a concave surface or an L-shaped surface.

In a further aspect of the disclosure, a nut plate secures the product to the first portion.

In still another aspect of the disclosure, the second portion includes a base plate and the first portion is rotatably coupled to the base plate. The base plate includes a button and the first portion includes a component for receiving the button.

In still a further aspect of the disclosure, the bracket is formed by a molding or extruding process.

The features, functions, and advantages that have been described above or will be discussed below can be achieved independently in various embodiments, or may be combined in yet other embodiments, further details of which can be seen with reference to the following description and drawings.

### BRIEF DESCRIPTION OF THE DRAWINGS

Embodiments of the present disclosure are described in detail below with reference to the following drawings.

FIG. 1 is a perspective view of a prior art utility bracket application;

FIGS. 2 and 3 are side views of prior art utility bracket applications;

FIGS. 4 and 5 are perspective views of a bracket formed in accordance with the present disclosure;

FIG. 6 is a side view of a bracket similar to the bracket shown in FIGS. 4 and 5;

FIG. 7 illustrates a perspective view of a bracket formed in accordance with the present disclosure;

FIG. 8 illustrates a side view of a portion of the bracket of FIG. 7;

FIG. 9 is a perspective view of the bracket of FIGS. 7 and 8 mounted to a structure and in support of the system component;

FIG. 10 illustrates a perspective view of a bracket formed in accordance with the present disclosure;

FIG. 11 illustrates a perspective view of the bracket of FIG. 10 mounted to a structure and in support of a system component;

FIGS. 12 and 14 illustrate side views of various brackets mounted to a structure and formed in accordance with the present disclosure;

FIG. 13 illustrates a perspective view of the bracket of FIG. 12 as mounted to a structure and supporting a system component;

FIGS. 15 and 17 illustrate side views of a bracket mounted to a structure and formed in accordance with the present disclosure;

FIG. 16 illustrates a perspective view of the bracket shown in FIG. 15 as mounted to a structure and supporting system components;

FIG. 18 illustrates an exploded view of a swivel bracket formed in accordance with the present disclosure;

FIG. 19 illustrates a perspective view of the bracket system shown in FIG. 18;

FIG. 20 illustrates a perspective view of a base of the swivel bracket shown in FIGS. 18 and 19; and

FIG. 21 illustrates a perspective view of the swivel bracket of FIGS. 18-20 that is in support of a system component.

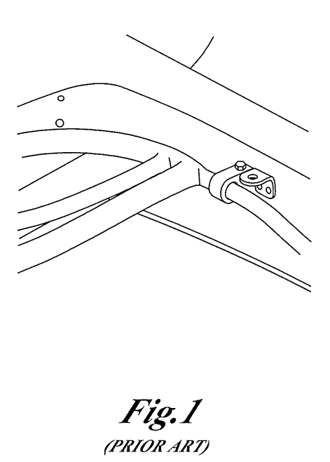

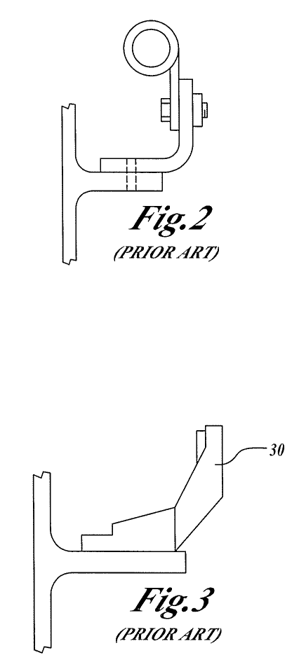

### DETAILED DESCRIPTION

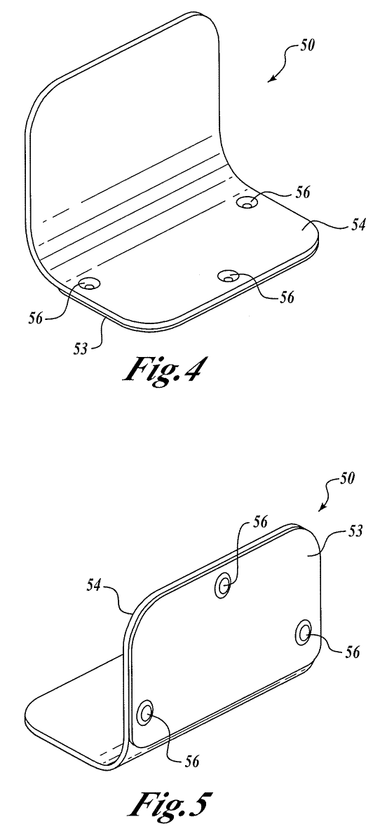

The present disclosure relates to utility brackets for attaching system components (e.g. wires or wire bundles) to a structure, such as an aircraft. Many specific details of certain embodiments of the disclosure are set forth in the following description and in FIGS. 4-21 to provide a thorough understanding of such embodiments. One skilled in the art will understand, however, that the present disclosure may have additional embodiments, or that the present disclosure may be practiced without several of the details described in the following description.

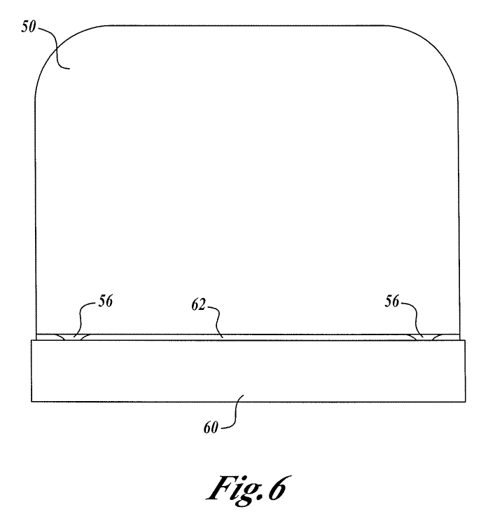

The present disclosure provides a utility bracket and a method for attaching the utility bracket to a structure in order to provide a quick and effective bond. Referring now to FIGS. 4 and 5, perspective views of an exemplary utility bracket 50 formed in accordance with the present disclosure are shown. The utility bracket 50 is suitably formed of metal, molded polycarbonate, or some other substance of sufficient thickness to provide suitable rigidity. The utility bracket 50 is bent, extruded, or molded into an approximate L-shape pattern with or without supports as necessary. A section 54 of the utility bracket 50 is stamped or molded with one or more dimples 56. The dimples 56 protrude from the utility bracket 50 on a convex side of the bracket 50.

Referring now to FIG. 6, the utility bracket 50 is attached to a support structure by mating the side where the dimples 56 protrude from the utility bracket 50 to the structure 60 after adhesive 62 has been applied to the support structure 60 or the utility bracket 50. The size of the dimples 56 is determined based on the amount of adhesive 62 that is desired between the utility bracket 50 and the support structure 60. The amount of desired adhesive is based on the type of adhesive (such as epoxies, acrylics, or polythioethers) and the recommended thickness to apply the adhesive and get the best bond. Thus, after the adhesive 62 has solidified or effected its bond between the utility bracket 50 and the support structure 60, the recommended thickness for the adhesive 62 will exist between the utility bracket 50 and the support structure 60 because of the size of the dimples 56.

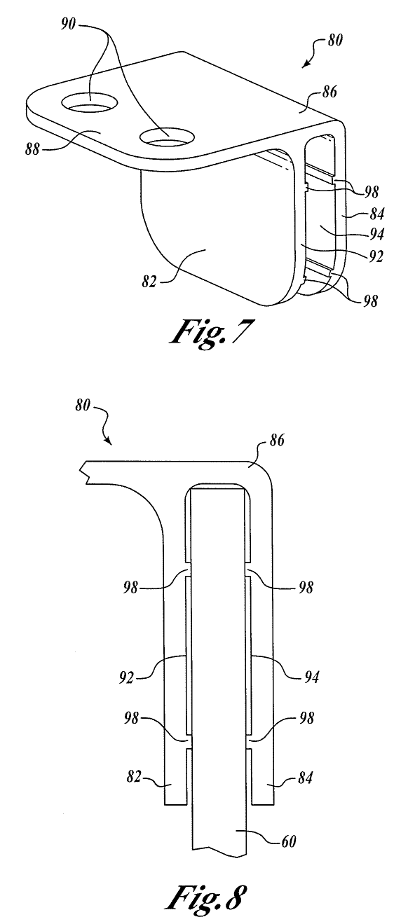

Referring now to FIG. 7, a bracket 80 formed in accordance with another embodiment of the present disclosure is shown. The utility bracket 80 includes first and second sides 82 and 84 that are connected to in an approximately parallel relationship to a base 86. A flange 88 extends from the base 86 and is approximately orthogonal to the first and second sides 82 and 84. The flange 88 includes one or more thru-holes 90 that are used for bolting on various items that the utility bracket 80 is designed to support, such as without limitation, a wire bundle clamp and holder (not shown). The first and second sides 82 and 84 include inward facing surfaces 92 and 94, respectively. Each of the inward facing surfaces 92 and 94 include one or more ridges 98. The gap formed between the first and second sides 82 and 84 receives a support structure.

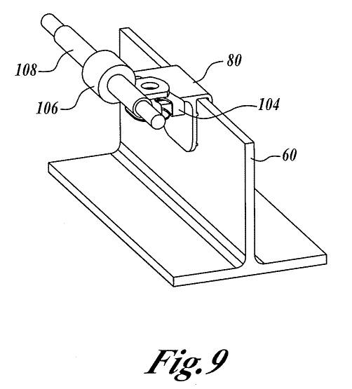

Referring now to FIG. 8, a side view of a portion of the utility bracket 80 mounted to the support structure 60 is shown. The ridges 98, formed on the inward surfaces 92 and 94, are formed of a sufficient thickness or height to allow an adhesive layer of a proper thickness to be applied between the first and second sides 82 and 84 and the support structure 60. The interior of the cavity that receives the support structure 60 is curved at the point where the inward facing surfaces 92 and 94 meet with the base 86. The amount of curvature applied is determined based on an amount of gap desired between the base 86 and an end of the support structure 60. Thus, the curvature sets the gap to be approximately equal to the optimum thickness for the adhesive that will be applied between the support structure 60 and the utility bracket 80.

Referring now to FIG. 9, the utility bracket 80 mounted and adhesively attached to the support structure 60 is shown. A nut plate attachment 104 is mounted through one of the thru-holes 90. A bolt (not shown) secures a clamp 106 to the nut plate attachment 104 and thus to the flange 88 of the utility bracket 80. In this example, the clamp 106 receives a wire bundle 108.

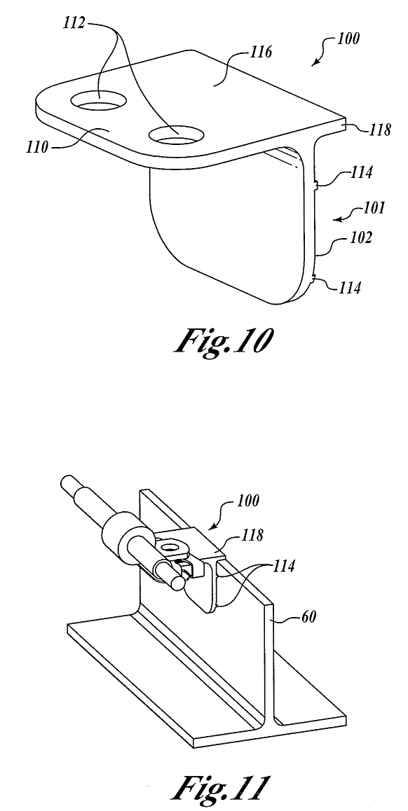

Referring now to FIG. 10, a utility bracket 100 similar to the bracket 80 (FIG. 7) is shown. The utility bracket 100 is roughly T-shaped with a stem 101 having a first side 102 with one or more ridges 114. A top portion 116 of the utility bracket 100 includes a first flange 118 that extends from the stem 101 from the first side 102. The first flange 118 extends a distance approximately equal to the thickness of a support structure that the utility bracket 100 will be adhered to. The top section 116 also includes a second flange 110 having one or more attachment holes 112.

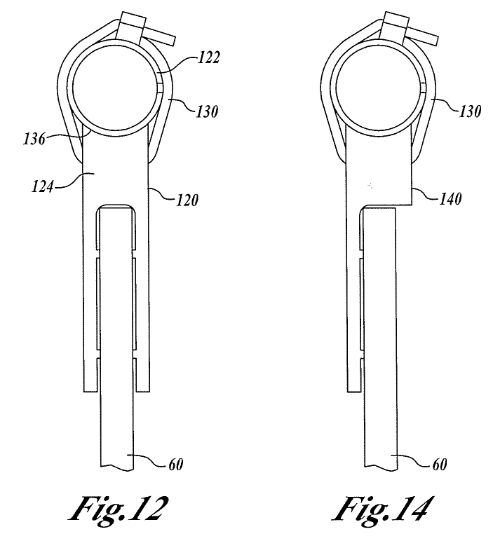

Referring now to FIG. 11, the utility bracket 100 adhered to the support structure 60 is shown. The flange 118 allows the utility bracket 100 to be quickly positioned on an edge of the frame structure 60. The ridges 114 maintain a gap between the utility bracket 100 and the support structure 60.

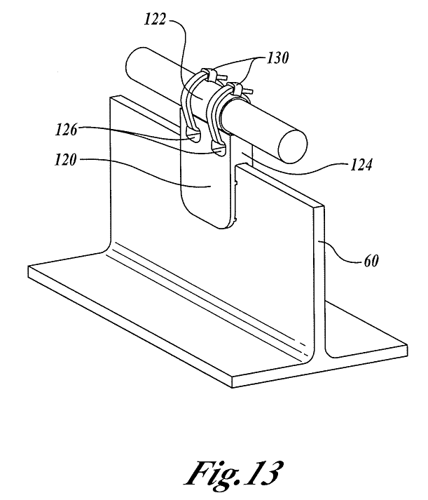

Referring now to FIGS. 12 and 13, a side-view of a utility bracket 120 that secures a clamp or sleeve device 122 to a support structure 60 is shown. The utility bracket 120 includes an attaching mechanism that is similar to that attaching the bracket 80 to the support structure 60 (FIGS. 7-9). The utility bracket 120 includes an end 124 having one or more thru-holes 126. One or more wire ties 130 or other securing mechanisms are received through the one or more thru-holes 126. An edge 136 of the utility bracket 120 opposite the portion that mounts to the support structure 60 is suitably curved to receive a clamp or sleeve 122. The wire ties 130 secure the clamp or sleeve device 122 to the edge 136. The edge 136 is formed with a similar radius of curvature as the clamp or sleeve device 122.

Referring now to FIG. 14, a utility bracket 140 that is similar to the utility bracket 120 (FIG. 12) is shown. The utility bracket 140 includes a similar structure that adheres the utility bracket 100 (FIG. 10) to the support structure 60. Otherwise, the utility bracket 140 is similar to the utility bracket 120 (FIG. 12).

Referring now to FIGS. 15 and 16, a utility bracket 150 similar to the utility bracket 120 (FIGS. 12 and 13) is shown. An end 152 of the utility bracket 150 that includes the thru-holes extends approximately orthogonal to a portion 156 of the utility bracket 150 that secures the utility bracket 150 to the support structure 60.

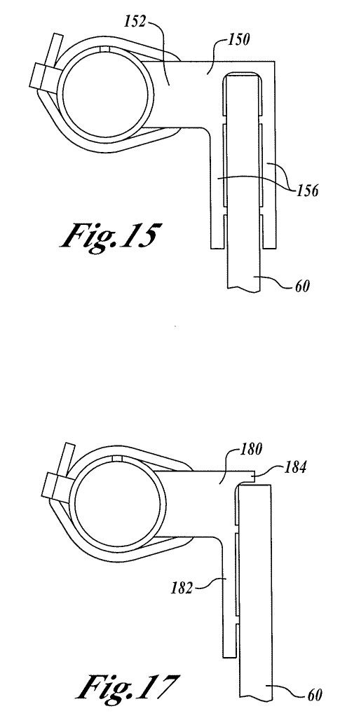

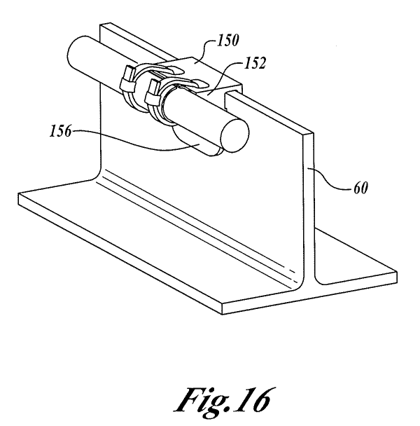

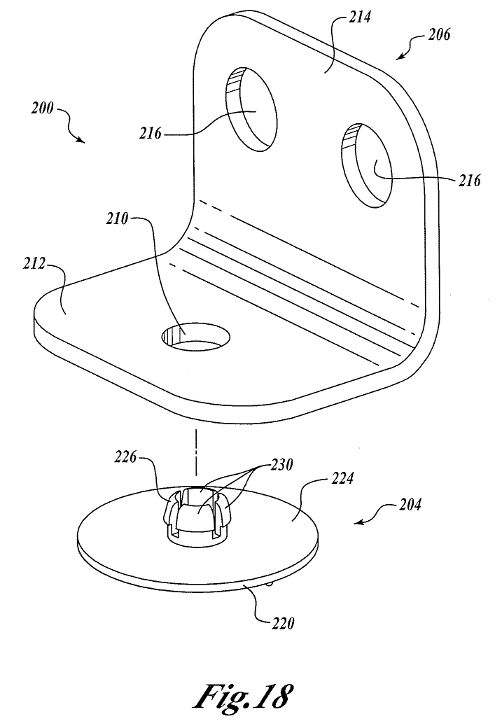

Referring now to FIG. 17, a utility bracket 180 similar to the utility bracket 150 (FIGS. 15 and 16) is shown, except that the utility bracket 180 only includes a single leg 182 and a flange 184 for mating with the support structure 60 (see FIGS. 10 and 14).

Referring now to FIGS. 18 and 19, a swivel bracket system 200 is shown. The swivel bracket system 200 includes a base plate 204 and a utility bracket 206. The utility bracket 206 is suitably L-shaped and includes a receiving hole 210 on a first portion 212. A second portion 214 of the utility bracket 206 includes one or more thru-holes 216 for receiving support clamps (not shown). The base plate 204 includes a first surface 220 that is adhesively attached to a support structure (not shown). A second surface 224 opposite the first surface 220 includes a swivel button 226 mounted to approximately the center of the base plate 204. The swivel button 226 includes two or more flexible leaves 230 that are flanged at a height above the second surface 224 that is approximately equal to or slightly larger than the thickness of the first portion 212. The swivel button 226 is received through the receiving hole 210 into a convex side of the utility bracket 206. As the swivel button 226 is received through the receiving hole 210, the leaves 230 flex inward until the flanged portion of the swivel button 226 passes through the receiving hole 210. After the swivel button 226 has passed through the receiving hole 210, the leaves 230 maintain their natural at rest position which places the flanges of the leaves 230 over the surface of the first portion 212 thus attaching the base plate 204 to the utility bracket 206. Once the base plate 204 is received through the receiving hole 210, the utility bracket 206 can swivel about the swivel button 226.

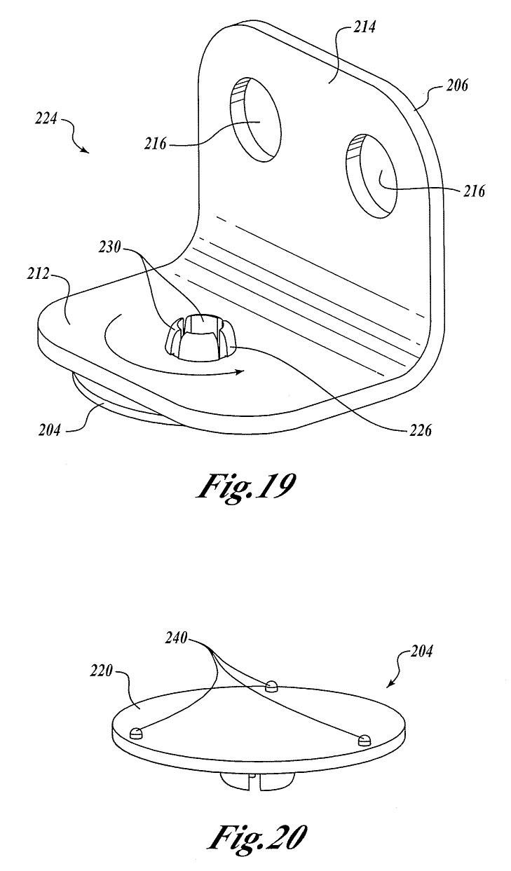

Referring now to FIG. 20, the first surface 220 of the base plate 204 includes one or more posts 240. The posts 240 are sized to provide a gap between the base plate 204 and a support structure (not shown), such that an optimum amount of adhesive is maintained between the base plate 204 and the support structure. It will be appreciated that the base plate 204 can be formed of metal, an injection-molded plastic, polymer, polycarbonate, or some other similar semi-rigid material.

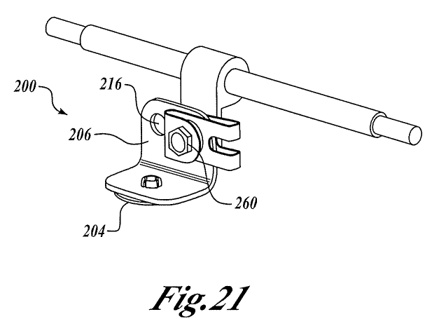

Referring now to FIG. 21, when the bracket system 200 is used, two axes of rotation allow aligning of wire bundles or other devices connected to the bracket system 200. The first axis of rotation is about a nut plate 260 that attaches to the bracket 206 through one of the thru-holes 216. The second axis of rotation is about the swivel button 226.

It will be appreciated that the brackets shown in FIGS. 4-21 may be produced by a various number of manufacturing techniques, such as without limitation, extruding, stamping, or molding performed on various materials, such as without limitation, various metals, alloys, plastics, or polycarbonates.

While the preferred embodiment of the disclosure has been illustrated and described, as noted above, many changes can be made without departing from the spirit and scope of the disclosure. Accordingly, the scope of the disclosure is not limited by the disclosure of the preferred embodiment. Instead, the disclosure should be determined entirely by reference to the claims that follow.

1. (canceled)

2. The apparatus of claim 17, wherein the separation protrusions include a plurality of ridges having a height equal to the optimal thickness of the adhesive layer.

3. The apparatus of claim 15, wherein the mounting surface is a concave surface for creating the adhesive gap.

4. The apparatus of claim 17, wherein the separation protrusions include dimples having a size equal to the optimal thickness of adhesive layer.

5. The apparatus of claim 15, wherein the first portion includes at least one thru-hole and at least one wire tie configured to secure the component to the first portion via the at least one thru-hole.

6-13. (canceled)

14. The apparatus of claim 19, wherein a longitudinal axis of the first portion is approximately orthogonal to the first and second opposing walls.

15. Apparatus comprising:
a support structure;
a utility bracket including a first portion for supporting a component and a second portion having a mounting surface, the second portion configured to create an adhesive gap between the mounting surface and a surface of the support structure; and
an adhesive layer for adhering the mounting surface of the bracket to the surface of the support structure, the adhesive layer filling the adhesive gap and contacting both the mounting surface and the support structure surface;
wherein the adhesive gap determines an optimal thickness of the adhesive layer.

16. The apparatus of claim 15, wherein the first portion is rotatably connected to the second portion.

17. The apparatus of claim 15, wherein the second component includes separation protrusions extending from the mounting surface to the support structure surface, and wherein the adhesive layer is between the separation protrusions.

18. The apparatus of claim 1, wherein the second portion includes a first wall providing the mounting surface and having the separation protrusions for separating the mounting surface from the support structure surface.

19. The apparatus of claim 18, wherein the second portion further includes a second wall opposing the first wall, the second wall having a second mounting surface and second separation protrusions for separating the second mounting surface from a second surface of the support structure; the bracket further comprising a second adhesive layer between and in contact with the second mounting and support surfaces.

20. The apparatus of claim 15, wherein the component is a wire bundle.

21. The apparatus of claim 15, wherein the support structure is an aircraft support structure.

22. Apparatus comprising:
an aircraft support structure;
a wire bundle;
a utility bracket including a first portion for supporting the wire bundle and a second portion having a mounting surface and separation protrusions for creating an adhesive gap between the mounting surface and a surface of the support structure; and
an adhesive layer for adhering the mounting surface of the bracket to the support structure surface, the adhesive layer filling the adhesive gap and contacting both the mounting surface and the support structure surface;
wherein the protrusions have a length equal to an optimal thickness of the adhesive layer.
